(19) United States
(12) Patent Application Publication
(10) Pub. No.: US 2025/0141112 A1
(43) Pub. Date: May 1, 2025

(54) ANTENNA ELEMENT AND ARRAY ANTENNA

(71) Applicant: KYOCERA CORPORATION, Kyoto-shi, Kyoto (JP)

(72) Inventor: Hiromichi YOSHIKAWA, Yokohama-shi, Kanagawa (JP)

(21) Appl. No.: 18/835,351

(22) PCT Filed: Feb. 1, 2023
(86) PCT No.: PCT/JP2023/003288

§ 371 Date: Aug. 2, 2024

(30) Foreign Application Priority Data
Feb. 3, 2022 (JP) 2022-015972

(51) Int. Cl. H01Q 9/04; H01Q 21/06

(52) U.S. Cl. CPC H01Q 9/0485; H01Q 21/061

(57) ABSTRACT

An antenna element includes a first conductor, a second conductor, a third conductor, and a fourth conductor disposed on a first surface of a base, a first coupling conductor located inside the base away from the first surface in a first direction and capacitively coupling the first conductor, the second conductor, the third conductor, and the fourth conductor to each other, a first power feeding conductor electromagnetically connected to any one of the first conductor, the second conductor, the third conductor, and the fourth conductor, and a second power feeding conductor electromagnetically connected to another conductor, among the first conductor, the second conductor, the third conductor, and the fourth conductor, the other conductor being different from the conductor to which the first power feeding conductor is electromagnetically connected.

### RELATED APPLICATIONS

The present application is a National Phase of International No. PCT/JP2023/003288, filed Feb. 1, 2023, which claims priority to Japanese application No. 2022-015972, filed Feb. 3, 2022.

### TECHNICAL FIELD

The present disclosure relates to an antenna element and an array antenna.

### BACKGROUND OF INVENTION

A known antenna can change directivity. For example, Patent Document 1 discloses a technique in which a combined directivity of a plurality of antenna elements exhibits unidirectionality.

### CITATION LIST

### Patent Literature

Patent Document 1: JP 2009-124642 A

### SUMMARY

An antenna element of the present disclosure is configured to include a first conductor, a second conductor, a third conductor, and a fourth conductor disposed on a first surface of a base, a first coupling conductor located inside the base away from the first surface in a first direction and capacitively coupling the first conductor, the second conductor, the third conductor, and the fourth conductor to each other, a first power feeding conductor electromagnetically connected to any one of the first conductor, the second conductor, the third conductor, and the fourth conductor, and a second power feeding conductor electromagnetically connected to another conductor, among the first conductor, the second conductor, the third conductor, and the fourth conductor, the other conductor being different from the one conductor to which the first power feeding conductor is electromagnetically connected.

An antenna element of the present disclosure is configured to include a first conductor provided with a first resonator, a second resonator, a third resonator, and a fourth resonator in a loop shape, in which the first conductor capacitively couples the first resonator, the second resonator, the third resonator, and the fourth resonator in common, resonators facing each other among the first resonator, the second resonator, the third resonator, and the fourth resonator are respectively provided with a first port and a second port inputting alternating currents of the same frequency, and the antenna element is configured to control a mode by a phase difference of the alternating currents of the same frequency from the first port and the second port.

An array antenna of the present disclosure includes a plurality of the antenna elements of the present disclosure.

### BRIEF DESCRIPTION OF THE DRAWINGS

FIG. 1 is a perspective view illustrating a configuration example of an antenna element according to a first embodiment.

FIG. 2 is a perspective view illustrating a configuration example of an antenna element according to a second embodiment.

FIG. 3 is a diagram showing a radiation pattern in a case where a phase difference between a first input signal and a second input signal is a first phase difference according to the second embodiment.

FIG. 4 is a diagram showing directivity in the case where the phase difference between the first input signal and the second input signal is the first phase difference according to the second embodiment.

FIG. 5 is a diagram showing frequency characteristics in the case where the phase difference between the first input signal and the second input signal is the first phase difference according to the second embodiment.

FIG. 6 is a diagram showing a radiation pattern in a case where the phase difference between the first input signal and the second input signal is a second phase difference according to the second embodiment.

FIG. 7 is a diagram showing directivity in the case where the phase difference between the first input signal and the second input signal is the second phase difference according to the second embodiment.

FIG. 8 is a diagram showing frequency characteristics in the case where the phase difference between the first input signal and the second input signal is the second phase difference according to the second embodiment.

FIG. 9 is a diagram showing a radiation pattern in a case where the phase difference between the first input signal and the second input signal is a third phase difference according to the second embodiment.

FIG. 10 is a diagram showing directivity in the case where the phase difference between the first input signal and the second input signal is the third phase difference according to the second embodiment.

FIG. 11 is a diagram showing frequency characteristics in a case where the phase difference between the first input signal and the second input signal is the third phase difference according to the first embodiment.

FIG. 12 is a diagram showing a radiation pattern in a case where the phase difference between the first input signal and the second input signal is a fourth phase difference according to the second embodiment.

FIG. 13 is a diagram showing directivity in a case where the phase difference between the first input signal and the second input signal is the fourth phase difference according to the first embodiment.

FIG. 14 is a diagram showing frequency characteristics in the case where the phase difference between the first input signal and the second input signal is the fourth phase difference according to the first embodiment.

FIG. 15 is a diagram showing a radiation pattern in a case where the phase difference between the first input signal and the second input signal is a fifth phase difference according to the second embodiment.

FIG. 16 is a diagram showing directivity in the case where the phase difference between the first input signal and the second input signal is the fifth phase difference according to the second embodiment.

FIG. 17 is a diagram showing frequency characteristics in a case where the phase difference between the first input signal and the second input signal is the fifth phase difference according to the second embodiment.

FIG. 18 is a perspective view illustrating a configuration example of an antenna according to a third embodiment.

FIG. 19 is a view illustrating a configuration example of an array antenna according to a fourth embodiment.

FIG. 20 is a view illustrating a configuration example of an array antenna according to a fifth embodiment.

FIG. 21 is a diagram showing a radiation pattern in a case where the array antenna according to the fifth embodiment is in a first mode.

FIG. 22 is a diagram showing directivity in the case where the array antenna according to the fifth embodiment is in the first mode.

FIG. 23 is a diagram showing a radiation pattern in a case where the array antenna according to the fifth embodiment is operated in a second mode.

FIG. 24 is a diagram showing directivity in the case where the array antenna according to the fifth embodiment is operated in the second mode.

### DESCRIPTION OF EMBODIMENTS

In the following, embodiments of the present disclosure will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X-axis in a horizontal plane is defined as an X-axis direction, a direction parallel to a Y-axis orthogonal to the X-axis in the horizontal plane is defined as a Y-axis direction, and a direction parallel to a Z-axis orthogonal to the horizontal plane is defined as a Z-axis direction. A plane including the X-axis and the Y-axis is appropriately referred to as an XY plane. A plane including the X-axis and the Z-axis is appropriately referred to as an XZ plane. A plane including the Y-axis and the Z-axis is appropriately referred to as a YZ plane. The XY plane is parallel to the horizontal plane. The XY plane, the XZ plane, and the YZ plane are orthogonal to each other.

### First Embodiment

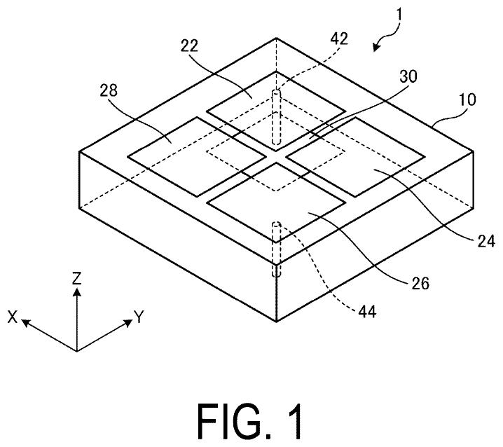

A configuration example of an antenna element according to a first embodiment will be described with reference to FIG. 1. FIG. 1 is a perspective view illustrating the configuration example of the antenna element according to the first embodiment.

As illustrated in FIG. 1, the antenna element 1 includes a base 10, a first conductor 22, a second conductor 24, a third conductor 26, a fourth conductor 28, a first coupling conductor 30, a first power feeding conductor 42, and a second power feeding conductor 44.

In the present embodiment, the antenna element 1 will be described as being formed in a quadrangular prism shape, but the present disclosure is not limited thereto. The antenna element 1 may be formed in a polygonal prism shape other than the quadrangular prism shape, a cylindrical shape, an elliptic cylindrical shape, or the like.

The antenna element 1 is configured to radiate waves at a predetermined resonant frequency. When the antenna element 1 resonates at the predetermined resonant frequency, the antenna element 1 radiates an electromagnetic wave. The antenna element 1 can use, as an operating frequency, at least one of resonant frequency bands of the antenna element 1. The antenna element 1 may radiate an electromagnetic wave of the operating frequency. A wavelength of the operating frequency may be an operating wavelength that is a wavelength of the electromagnetic wave with the operating frequency of the antenna element 1. At the same time, under the condition of signal input, the antenna element 1 behaves as an antenna with a different radiation pattern at the same operating frequency. For the occurrence of such a phenomenon, a signal condition is required in which two different modes are adjusted so as to have the same frequency and the two modes can be selectively excited.

The antenna element 1, as will be described below, exhibits an artificial magnetic conductor character with respect to an electromagnetic wave with a predetermined frequency incident on a surface of the antenna element 1 substantially parallel with an XY plane from the positive direction of a Z-axis. In the present disclosure, the “artificial magnetic conductor character” means a characteristic of a surface where a phase difference between an incident wave and a reflected wave at the operating frequency is 0 degrees. On the surface having the artificial magnetic conductor character, the phase difference between the incident wave and the reflected wave in the operating frequency band ranges from −90 degrees to +90 degrees. The operating frequency band includes the resonant frequency and the operating frequency that exhibit the artificial magnetic conductor character.

The base 10 is a base made of a dielectric material.

The first conductor 22, the second conductor 24, the third conductor 26, and the fourth conductor 28 are disposed on an upper surface of the base 10. The upper surface of the base 10 is also referred to as a first surface. The first conductor 22, the second conductor 24, the third conductor 26, and the fourth conductor 28 are conductors extending in the XY plane direction. Each of the first conductor 22, the second conductor 24, the third conductor 26, and the fourth conductor 28 is, for example, a resonator having a square shape. The first conductor 22, the second conductor 24, the third conductor 26, and the fourth conductor 28 are disposed in a square lattice shape. Each of the first conductor 22, the second conductor 24, the third conductor 26, and the fourth conductor 28 is formed to have substantially the same surface area in the XY plane.

A predetermined gap is formed between the first conductor 22 and the second conductor 24. A predetermined gap is formed between the second conductor 24 and the third conductor 26. A predetermined gap is formed between the third conductor 26 and the fourth conductor 28. The first conductor 22 to the fourth conductor 28 are configured to be capacitively connected to each other.

Each of the first conductor 22, the second conductor 24, the third conductor 26, and the fourth conductor 28 will described as being formed in the square shape, but the present disclosure is not limited thereto. Each of the first conductor 22, the second conductor 24, the third conductor 26, and the fourth conductor 28 may have, for example, a polygonal shape other than the square shape, a circular shape, or an elliptical shape. The first conductor 22, the second conductor 24, the third conductor 26, and the fourth conductor 28 may be different from each other in the surface area and/or the shape in the XY plane.

The first coupling conductor 30, a third coupling conductor 32, a fourth coupling conductor 34, a fifth coupling conductor 36, and a sixth coupling conductor 38 may be located inside the base 10 away from the upper surface of the base 10 in the Z-axis direction. The Z-axis direction is also referred to as a first direction. The first coupling conductor 30, the third coupling conductor 32, the fourth coupling conductor 34, the fifth coupling conductor 36, and the sixth coupling conductor 38 are conductors extending in the XY plane direction.

The first coupling conductor 30 is formed, for example, in a square shape. The first coupling conductor 30 is disposed at a position away from the upper surface of the base 10 in the Z-axis direction and overlapping the first conductor 22, the second conductor 24, the third conductor 26, and the fourth conductor 28. The first coupling conductor 30 capacitively is configured to connect the first conductor 22, the second conductor 24, the third conductor 26, and the fourth conductor 28 to each other. The first coupling conductor 30 will be described as being formed in a square shape, but the present disclosure is not limited thereto. The first coupling conductor 30 may have, for example, a polygonal shape other than a square shape, a circular shape, or an elliptical shape.

One end of the first power feeding conductor 42 is configured to be electromagnetically connected to the first conductor 22, and the other end thereof is electromagnetically connected to a first power feeding point (not illustrated). The first power feeding conductor 42 may be, for example, a via formed in the base 10.

One end of the second power feeding conductor 44 is configured to be electromagnetically connected to the third conductor 26, and the other end thereof is electromagnetically connected to a second power feeding point (not illustrated). The second power feeding conductor 44 may be, for example, a via formed in the base 10.

The first power feeding conductor 42 and the second power feeding conductor 44 are configured to be disposed so as to be located on a diagonal line connecting a vertex of the first conductor 22 and a vertex of the third conductor 26 in the first conductor 22, the second conductor 24, the third conductor 26, and the fourth conductor 28 disposed in the square lattice shape.

A predetermined first input signal is input to the first conductor 22 from the first power feeding conductor 42. A predetermined second input signal is input to the third conductor 26 from the second power feeding conductor 44. The first input signal and the second input signal have the same frequency. In the present embodiment, a phase difference between a phase of the first input signal and a phase of the second input signal can be arbitrarily changed. The present embodiment is configured to change directivity of the antenna element 1 by changing the phase difference between the first input signal and the second input signal.

### Second Embodiment

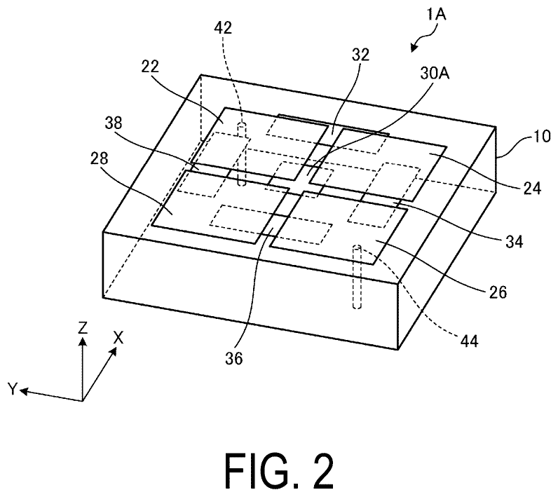

A configuration example of an antenna element according to a second embodiment will be described with reference to FIG. 2. FIG. 2 is a perspective view illustrating the configuration example of the antenna element according to the second embodiment.

As illustrated in FIG. 2, an antenna element 1A includes the base 10, the first conductor 22, the second conductor 24, the third conductor 26, the fourth conductor 28, a second coupling conductor 30A, the third coupling conductor 32, the fourth coupling conductor 34, the fifth coupling conductor 36, the sixth coupling conductor 38, the first power feeding conductor 42, and the second power feeding conductor 44. The antenna element 1A differs from the antenna element 1 illustrated in FIG. 1 in that the antenna element 1A includes the second coupling conductor 30A, the third coupling conductor 32, the fourth coupling conductor 34, the fifth coupling conductor 36, and the sixths coupling conductor 38, instead of the first coupling conductor 30.

The second coupling conductor 30A is formed, for example, in a square shape. The second coupling conductor 30A is disposed at a position away from the upper surface of the base 10 in the Z-axis direction and overlapping the first conductor 22, the second conductor 24, the third conductor 26, and the fourth conductor 28. The second coupling conductor 30A is smaller than the first coupling conductor 30 illustrated in FIG. 1. The second coupling conductor 30A is configured to capacitively connect the first conductor 22, the second conductor 24, the third conductor 26, and the fourth conductor 28 to each other. The second coupling conductor 30A will be described as being formed in the square shape, but the present disclosure is not limited thereto. The second coupling conductor 30A may have, for example, a polygonal shape other than a square shape, a circular shape, or an elliptical shape.

Each of the third coupling conductor 32, the fourth coupling conductor 34, the fifth coupling conductor 36, and the sixth coupling conductor 38 is formed, for example, in a rectangular shape. Each of the third coupling conductor 32, the fourth coupling conductor 34, the fifth coupling conductor 36, and the sixth coupling conductor 38 is formed in substantially the same size. Each of the third coupling conductor 32, the fourth coupling conductor 34, the fifth coupling conductor 36, and the sixth coupling conductor 38 will be described as being formed in the rectangular shape, but the present disclosure is not limited thereto. Each of the third coupling conductor 32, the fourth coupling conductor 34, the fifth coupling conductor 36, and the sixth coupling conductor 38 may have, for example, a polygonal shape other than a rectangular shape, a circular shape, or an elliptical shape.

The third coupling conductor 32 is disposed at a position away from the upper surface of the base 10 in the Z-axis direction and overlapping the first conductor 22 and the second conductor 24. The third coupling conductor 32 is configured to capacitively connect the first conductor 22 and the second conductor 24 to each other.

The fourth coupling conductor 34 is disposed at a position away from the upper surface of the base 10 in the Z-axis direction and overlapping the second conductor 24 and the third conductor 26. The fourth coupling conductor 34 is configured to capacitively connect the second conductor 24 and the third conductor 26 to each other.

The fifth coupling conductor 36 is disposed at a position away from the upper surface of the base 10 in the Z-axis direction and overlapping the third conductor 26 and the fourth conductor 28. The fifth coupling conductor 36 is configured to capacitively connect the third conductor 26 and the fourth conductor 28 to each other.

The sixth coupling conductor 38 is disposed at a position away from the upper surface of the base 10 in the Z-axis direction and overlapping the fourth conductor 28 and the first conductor 22. The sixth coupling conductor 38 is configured to capacitively connect the fourth conductor 28 and the first conductor 22 to each other.

### Radiation Pattern

A radiation pattern of a radio wave of the antenna element according to the second embodiment will be described. In the second embodiment, the antenna element 1A can control the radiation pattern of the radio wave by controlling the phase difference between the first input signal input to the first conductor 22 and the second input signal input to the third conductor 26.

### First Phase Difference

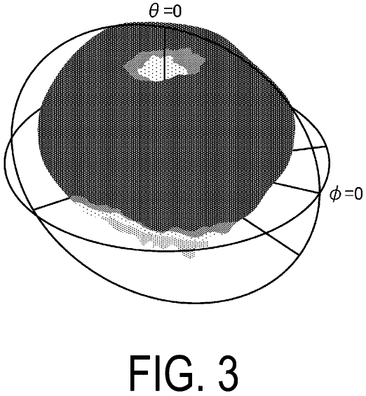

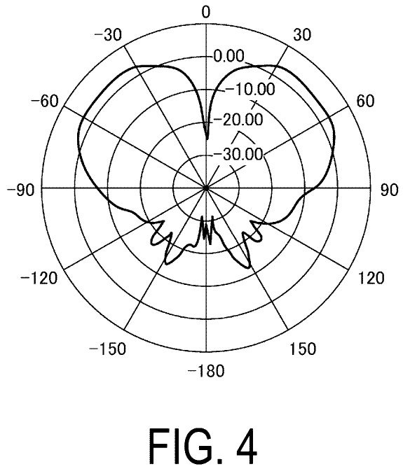

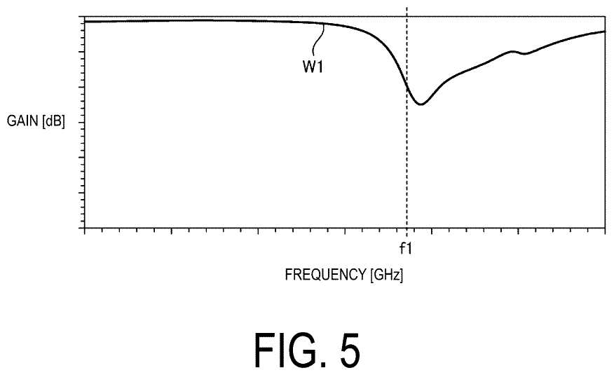

FIG. 3 is a diagram showing a radiation pattern in a case where the phase difference between the first input signal and the second input signal is a first phase difference according to the second embodiment. FIG. 4 is a diagram showing directivity in the case where the phase difference between the first input signal and the second input signal is the first phase difference according to the second embodiment. FIG. 5 is a diagram showing frequency characteristics in the case where the phase difference between the first input signal and the second input signal is the first phase difference according to the second embodiment. In the second embodiment, the first phase difference is 0 degrees.

When the phase difference between the first input signal and the second input signal is 0 degrees, the maximum value of a gain value of the antenna may be, for example, +6.3 [decibels (dBi)]. As illustrated in FIGS. 3 and 4, when the phase difference between the first input signal and the second input signal is 0 degrees, the antenna element 1A may enter a mode in which the electromagnetic wave is not radiated forward. In a waveform W1 shown in FIG. 5, a horizontal axis represents frequencies [gigahertz (GHz)] and a vertical axis represents gains [decibels (dB)] of a reflection coefficient. A frequency f1 indicated by the waveform W1 is a resonant frequency of the antenna element 1A when the phase difference between the first input signal and the second input signal is 180 degrees. The gain near the frequency f1 of the waveform W1 of the reflection characteristic may be about −10 [dB].

### Second Phase Difference

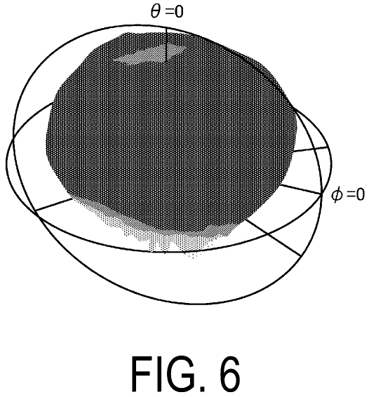

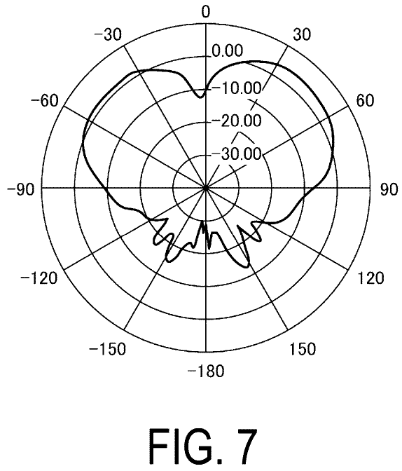

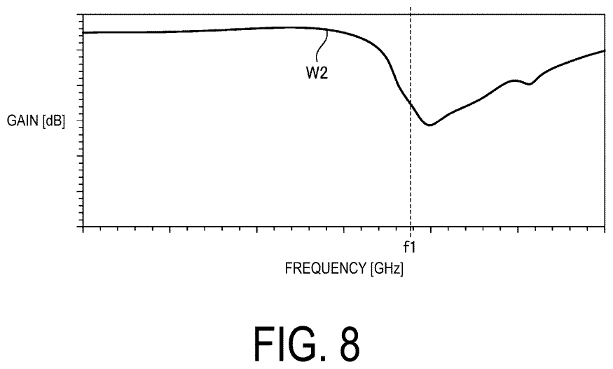

FIG. 6 is a diagram showing a radiation pattern in a case where the phase difference between the first input signal and the second input signal is a second phase difference according to the second embodiment. FIG. 7 is a diagram showing directivity in the case where the phase difference between the first input signal and the second input signal is the second phase difference according to the second embodiment. FIG. 8 is a diagram showing frequency characteristics in the case where the phase difference between the first input signal and the second input signal is the second phase difference according to the second embodiment. In the second embodiment, the second phase difference is 45 degrees.

When the phase difference between the first input signal and the second input signal is 45 degrees, the maximum value of the gain value of the antenna may be, for example, +6.5 [dBi]. As illustrated in FIGS. 6 and 7, when the phase difference between the first input signal and the second input signal is 45 degrees, the antenna element 1A may enter a mode in which the electromagnetic wave is radiated more forward than when the phase difference between the first input signal and the second input signal is 0 degrees. In a waveform W2 shown in FIG. 8, a horizontal axis represents frequencies [GHz] and a vertical axis represents gains [dB] of a reflection coefficient. The gain near the frequency f1 of the waveform W2 may be about −12 [dB].

### Third Phase Difference

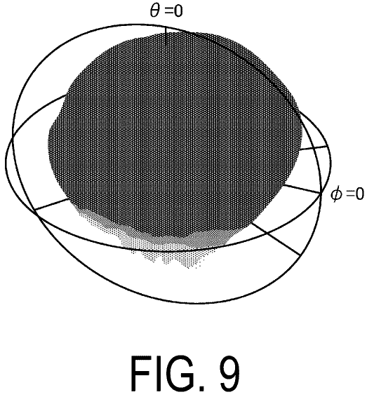

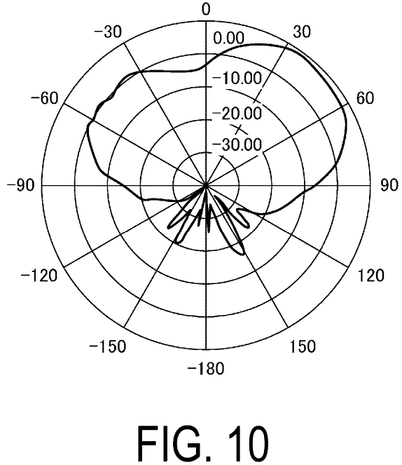

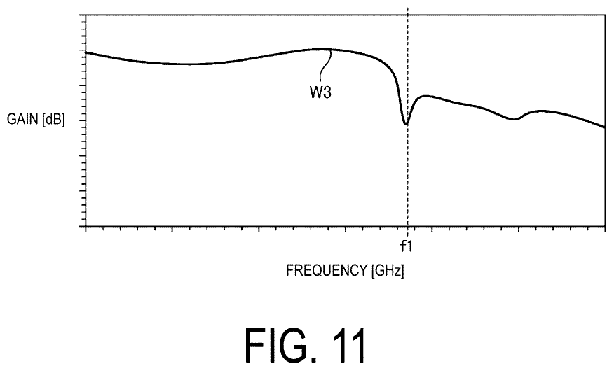

FIG. 9 is a diagram showing a radiation pattern in a case where the phase difference between the first input signal and the second input signal is a third phase difference according to the second embodiment. FIG. 10 is a diagram showing directivity in the case where the phase difference between the first input signal and the second input signal is the third phase difference according to the second embodiment. FIG. 11 is a diagram showing frequency characteristics in a case where the phase difference between the first input signal and the second input signal is the third phase difference according to the second embodiment. In the second embodiment, the third phase difference is 90 degrees.

When the phase difference between the first input signal and the second input signal is 0 degrees, the maximum value of the gain value of the antenna may be, for example, +6.5 [dBi]. As illustrated in FIGS. 9 and 10, when the phase difference between the first input signal and the second input signal is 90 degrees, the antenna element 1A may enter a mode in which the electromagnetic wave is radiated obliquely forward to the right. In a waveform W3 shown in FIG. 11, a horizontal axis represents frequencies [GHz] and a vertical axis represents gains [dB] of a reflection coefficient. The gain near the frequency f1 of the waveform W3 may be about −15 [dB].

### Fourth Phase Difference

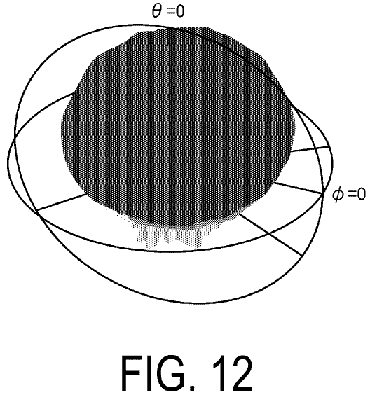

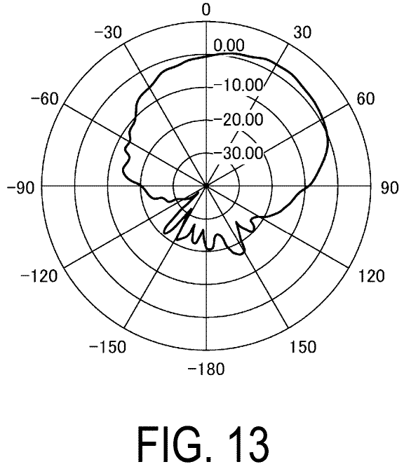

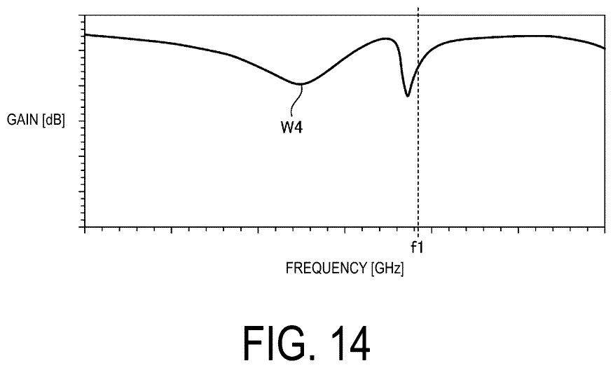

FIG. 12 is a diagram showing a radiation pattern in a case where the phase difference between the first input signal and the second input signal is a fourth phase difference according to the second embodiment. FIG. 13 is a diagram showing directivity in a case where the phase difference between the first input signal and the second input signal is the fourth phase difference according to the first embodiment. FIG. 14 is a diagram showing frequency characteristics in the case where the phase difference between the first input signal and the second input signal is the fourth phase difference according to the first embodiment. In the second embodiment, the fourth phase difference is 135 degrees.

When the phase difference between the first input signal and the second input signal is 135 degrees, the maximum value of the gain value of the antenna may be, for example, +6.4 [dBi]. As illustrated in FIGS. 12 and 13, when the phase difference between the first input signal and the second input signal is 135 degrees, the antenna element 1A may enter a mode in which the electromagnetic wave is radiated obliquely forward to the right. In a waveform W4 shown in FIG. 14, a horizontal axis represents frequencies [GHz] and a vertical axis represents gains [dB] of a reflection coefficient. The gain near the frequency f1 of the waveform W4 may be about −7 [dB].

### Fifth Phase Difference

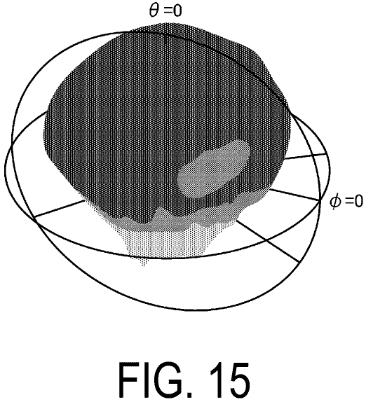

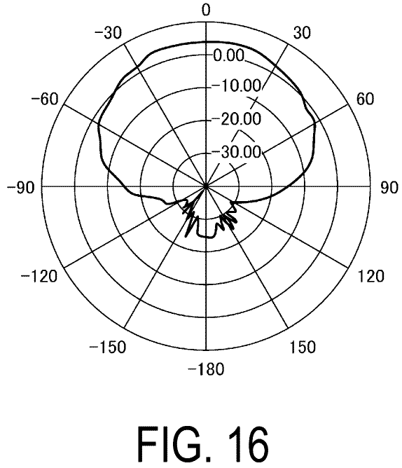

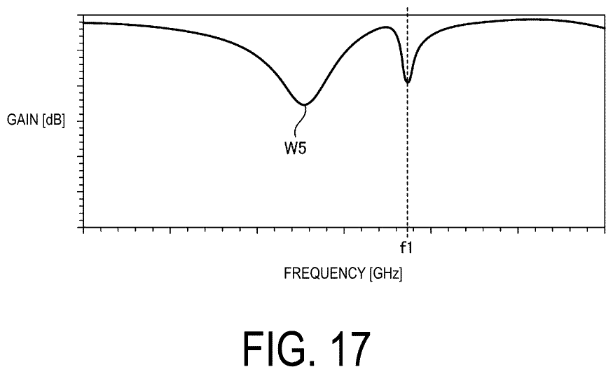

FIG. 15 is a diagram showing a radiation pattern in a case where the phase difference between the first input signal and the second input signal is a fifth phase difference according to the second embodiment. FIG. 16 is a diagram showing directivity in the case where the phase difference between the first input signal and the second input signal is the fifth phase difference according to the second embodiment. FIG. 17 is a diagram showing frequency characteristics in a case where the phase difference between the first input signal and the second input signal is the fifth phase difference according to the second embodiment. In the first embodiment, the fifth phase difference is 180 degrees.

When the phase difference between the first input signal and the second input signal is 180 degrees, the maximum value of the gain value of the antenna may be, for example, +6.7 [dBi]. As illustrated in FIGS. 15 and 16, when the phase difference between the first input signal and the second input signal is 180 degrees, the antenna element 1A may enter a mode in which the electromagnetic wave is radiated forward. In a waveform W5 shown in FIG. 17, a horizontal axis represents frequencies [GHz] and a vertical axis represents gains [dB] of a reflection coefficient. The gain near the frequency f1 of the waveform W5 may be about −15 [dB].

As illustrated in FIGS. 3 to 17, in the antenna element 1A, when the phase difference between the first input signal and the second input signal is between 0 degrees and 180 degrees, the maximum values of the gain values of the antenna are substantially the same. That is, the antenna element 1A functions as the antenna when the phase difference between the first input signal and the second input signal is between 0 degrees and 180 degrees. In the antenna element 1A, a radiation direction of the electromagnetic wave may be different in accordance with the phase difference between the first input signal and the second input signal. That is, the antenna element 1A can control the radiation direction of the electromagnetic wave by adjusting the phase difference between the first input signal and the second input signal.

As described above, in the second embodiment, the radiation direction of the electromagnetic wave can be controlled by adjusting the phase difference between the first input signal and the second input signal. Thus, according to the second embodiment, the antenna element can be obtained in which a size can be reduced and antenna directivity can be changed.

### Third Embodiment

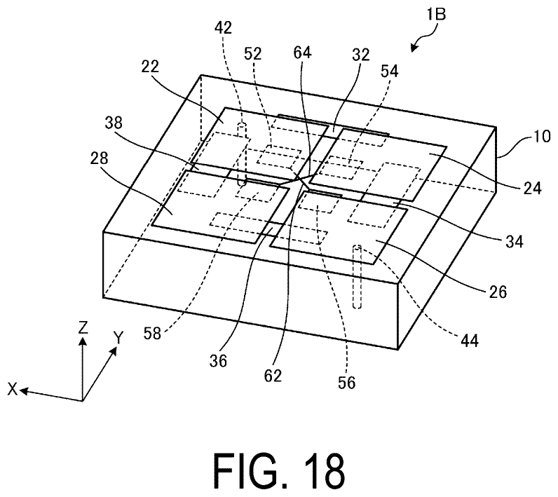

A configuration example of an antenna according to a third embodiment will be described with reference to FIG. 18. FIG. 18 is a perspective view illustrating the configuration example of the antenna according to the third embodiment.

As illustrated in FIG. 18, an antenna element 1B includes the base 10, the first conductor 22, the second conductor 24, the third conductor 26, the fourth conductor 28, a seventh coupling conductor 52, an eighth coupling conductor 54, a ninth coupling conductor 56, a tenth coupling conductor 58, a first connector 62, and a second connector 64. The antenna element 1B differs from the antenna element 1A illustrated in FIG. 2 in that the antenna element 1B includes the eighth coupling conductor 54, the ninth coupling conductor 56, the tenth coupling conductor 58, the first connector 62, and the second connector 64, instead of the second coupling conductor 30A.

The seventh coupling conductor 52, the eighth coupling conductor 54, the ninth coupling conductor 56, and the tenth coupling conductor 58 may be located inside the base 10 away from the upper surface of the base 10 in the Z-axis direction. The seventh coupling conductor 52, the eighth coupling conductor 54, the ninth coupling conductor 56, and the tenth coupling conductor 58 are formed on the same plane inside the base 10. Each of the seventh coupling conductor 52, the eighth coupling conductor 54, the ninth coupling conductor 56, and the tenth coupling conductor 58 is formed, for example, in a square shape. Each of the seventh coupling conductor 52, the eighth coupling conductor 54, the ninth coupling conductor 56, and the tenth coupling conductor 58 is formed in substantially the same shape. The seventh coupling conductor 52, the eighth coupling conductor 54, the ninth coupling conductor 56, and the tenth coupling conductor 58 are smaller than the first conductor 22, the second conductor 24, the third conductor 26, and the fourth conductor 28, respectively. Each of the seventh coupling conductor 52, the eighth coupling conductor 54, the ninth coupling conductor 56, and the tenth coupling conductor 58 will be described as being formed in the square shape, but the present disclosure is not limited thereto. Each of the seventh coupling conductor 52, the eighth coupling conductor 54, the ninth coupling conductor 56, and the tenth coupling conductor 58 may have, for example, a polygonal shape other than a square shape, a circular shape, or an elliptical shape.

The seventh coupling conductor 52 is disposed at a position away from the upper surface of the base 10 in the Z-axis direction so that at least a part of the seventh coupling conductor 52 overlaps the first conductor 22.

The eighth coupling conductor 54 is disposed at a position away from the upper surface of the base 10 in the Z-axis direction so that at least a part of the eighth coupling conductor 54 overlaps the second conductor 24.

The ninth coupling conductor 56 is disposed at a position away from the upper surface of the base 10 in the Z-axis direction so that at least a part of the ninth coupling conductor 56 overlaps the third conductor 26.

The tenth coupling conductor 58 is disposed at a position away from the upper surface of the base 10 in the Z-axis direction so that at least a part of the tenth coupling conductor 58 overlaps the fourth conductor 28.

The first connector 62 is configured to electromagnetically connect the seventh coupling conductor 52 and the ninth coupling conductor 56 to each other. One end of the first connector 62 is configured to be electromagnetically connected to a vertex of the seventh coupling conductor 52 facing the ninth coupling conductor 56, and the other end thereof is electromagnetically connected to a vertex of the ninth coupling conductor 56 facing the seventh coupling conductor 52.

The second connector 64 is configured to electromagnetically connect the eighth coupling conductor 54 and the tenth coupling conductor 58 to each other. One end of the second connector 64 is configured to be electromagnetically connected to a vertex of the eighth coupling conductor 54 facing the tenth coupling conductor 58, and the other end thereof is electromagnetically connected to a vertex of the tenth coupling conductor 58 facing the eighth coupling conductor 54.

The first connector 62, and the second connector 64 are configured to be electromagnetically connected to each other. The first connector 62 and the second connector 64 are configured to be electromagnetically connected to each other at an intersection between a straight line connecting the seventh coupling conductor 52 and the eighth connector 76 to each other and a straight line connecting the eighth coupling conductor 54 and the tenth coupling conductor 58 to each other.

The seventh coupling conductor 52, the eighth coupling conductor 54, the ninth coupling conductor 56, the tenth coupling conductor 58, the first connector 62, and the second connector 64 are configured to capacitively connect the first conductor 22, the second conductor 24, the third conductor 26, and the fourth conductor 28 to each other.

When the antenna element 1B is manufactured, for example, variations may occur in relative positions between the first conductor 22 to the fourth conductor 28 and the seventh coupling conductor 52 to the tenth coupling conductor 58, respectively. When the positions of the seventh coupling conductor 52 to the tenth coupling conductor 58 are shifted with respect to the first conductor 22 to the fourth conductor 28, respectively, the magnitude of capacitive coupling changes, which may affect characteristics of the antenna element 1B. Here, the seventh coupling conductor 52 to the tenth coupling conductor 58 are smaller than the first conductor 22 to the fourth conductor 28, respectively. Thus, when manufacturing the antenna element 1B, it is relatively easy to manufacture it so that portions where the seventh to tenth coupling conductors 52 to 58 do not overlap the first to fourth conductors 22 to 28, respectively, are small. That is, in the third embodiment, the variations in the magnitude of capacitive coupling between the first to fourth conductors 22 to 28 and the seventh to tenth coupling conductors 52 to 58, respectively, can be reduced, and thus variation in the characteristics of the antenna element 1B can be reduced.

As described above, in the third embodiment, the first to fourth conductors 22 to 28 are capacitively coupled by the seventh to tenth coupling conductors 52 to 58, respectively, so that variations in the characteristics of the antenna element 1B can be reduced. Thus, the third embodiment can stabilize the characteristics of the antenna element 1B.

### Fourth Embodiment

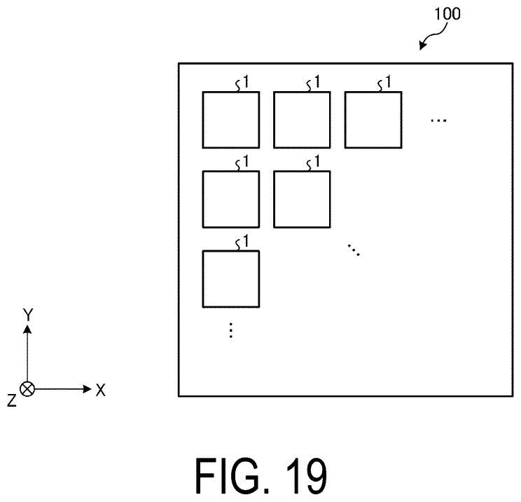

A fourth embodiment of the present disclosure will be described. FIG. 19 is a view illustrating a configuration example of an array antenna according to a fourth embodiment.

As illustrated in FIG. 19, an array antenna 100 includes a plurality of antenna elements 1. The plurality of antenna elements 1 are disposed, for example, at predetermined intervals along the X-axis and the Y-axis. For example, the plurality of antenna elements 1 may be disposed at equal intervals or at unequal intervals along the X-axis and the Y-axis. The plurality of antenna elements 1 may be disposed at equal intervals or at unequal intervals along an oblique direction in the XY plane. By changing the phase difference between the first input signal and the second input signal input to each of the plurality of antenna elements 1, the array antenna 100 can change the directivity.

### Fifth Embodiment

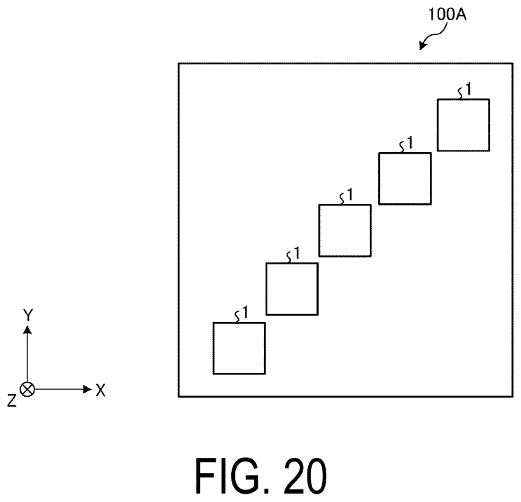

A fifth embodiment of the present disclosure will be described. FIG. 20 is a view illustrating a configuration example of an array antenna according to the fifth embodiment.

As illustrated in FIG. 20, in the array antenna 100A, five antenna elements 1 are arranged along an oblique direction in the XY plane. In the array antenna 100A, by changing the phase difference between the first input signal and the second input signal input to each of the five antenna elements 1, the directivity of the array 100A can be changed.

### First Mode

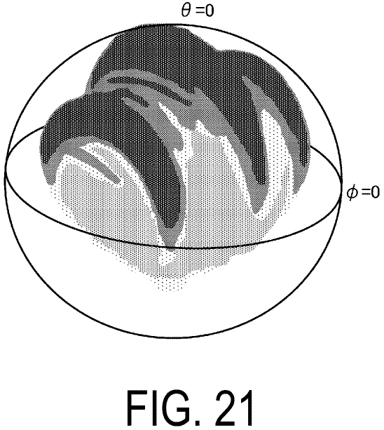

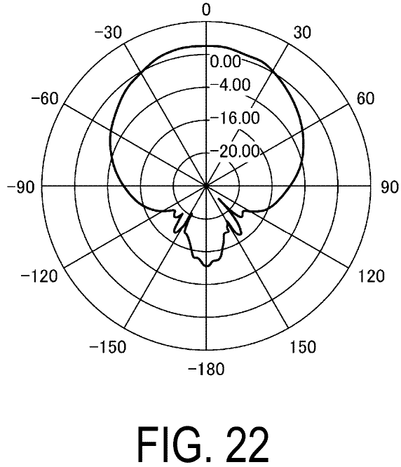

An operation mode of the array antenna according to the fifth embodiment will be described with reference to FIGS. 21 and 22. FIG. 21 is a diagram showing a radiation pattern in a case where the array antenna according to the fifth embodiment is in a first mode. FIG. 22 is a diagram showing directivity in the case where the array antenna according to the fifth embodiment is in the first mode.

In the fifth embodiment, the first mode refers to an operation mode in which the phase difference between the first input signal and the second input signal is 180 degrees in all of the five antenna elements in the array antenna 100A. As illustrated in FIG. 21, unevenness occurs in the radiation pattern of the array antenna 100A in the first mode between a place where the antenna element 1 is disposed and a place where the antenna element 1 is not disposed. As illustrated in FIG. 22, in the first mode, as a result of superposition of the electromagnetic waves radiated from the five antenna elements 1, the array antenna 100A functions as an antenna having directivity in the positive direction of the Z-axis direction in the example illustrated in FIG. 20.

### Second Mode

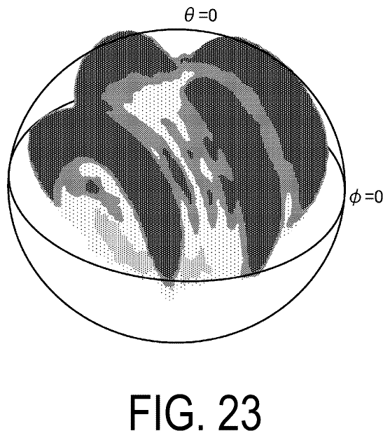

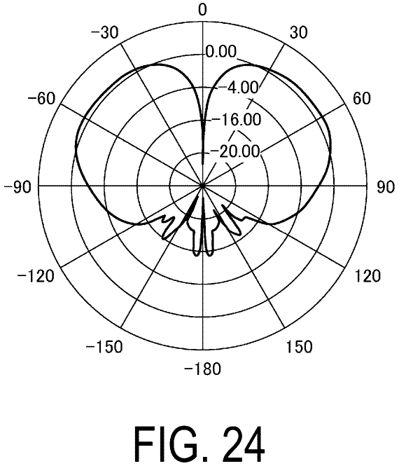

An operation mode of the array antenna according to the fifth embodiment will be described with reference to FIGS. 23 and 24. FIG. 23 is a diagram showing a radiation pattern in a case where the array antenna according to the fifth embodiment is operated in a second mode. FIG. 24 is a diagram showing directivity in the case where the array antenna according to the fifth embodiment is operated in the second mode.

In the fifth embodiment, the second mode refers to an operation mode in which the phase difference between the first input signal and the second input signal is 0 degrees in all of the five antenna elements in the array antenna 100A. As illustrated in FIG. 23, unevenness occurs in the radiation pattern of the array antenna 100A in the second mode between a place where the antenna element 1 is disposed and a place where the antenna element 1 is not disposed. As illustrated in FIG. 24, in the second mode, as a result of superposition of the electromagnetic waves radiated from the five antenna elements 1, the array antenna 100A functions as an antenna not having directivity in the positive direction of the Z-axis direction in the example illustrated in FIG. 20.

As described above, in the fifth embodiment, by controlling the phase difference between the first input signal and the second input signal input to each of the antenna elements included in the array antenna, the directivity of the array antenna can be controlled.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

1. An antenna element comprising:
a first conductor, a second conductor, a third conductor, and a fourth conductor disposed on a first surface of a base;
a first coupling conductor located inside the base away from the first surface in a first direction and configured to capacitively couple the first conductor, the second conductor, the third conductor, and the fourth conductor to each other;
a first power feeding conductor electromagnetically connected to any one of the first conductor, the second conductor, the third conductor, and the fourth conductor; and
a second power feeding conductor electromagnetically connected to another conductor among the first conductor, the second conductor, the third conductor, and the fourth conductor, the other conductor being different from the one conductor to which the first power feeding conductor is electromagnetically connected.

2. The antenna element according to claim 1, wherein
the first conductor, the second conductor, the third conductor, and the fourth conductor are disposed in a square lattice shape, and
the first coupling conductor comprises
a second coupling conductor configured to capacitively couple the first conductor, the second conductor, the third conductor, and the fourth conductor to each other.
a third coupling conductor located on the same plane as the second coupling conductor and configured to capacitively couple the first conductor and the second conductor to each other,
a fourth coupling conductor located on the same plane as the second coupling conductor and configured to capacitively couple the second conductor and the third conductor to each other,
a fifth coupling conductor located on the same plane as the second coupling conductor and configured to capacitively couple the third conductor and the fourth conductor to each other, and
a sixth coupling conductor located on the same plane as the second coupling conductor and configured to capacitively couple the fourth conductor and the first conductor to each other.

3. The antenna element according to claim 2, wherein
the second coupling conductor is disposed at a position away in the first direction to overlap the first conductor, the second conductor, the third conductor, and the fourth conductor,
the third coupling conductor is disposed at a position away in the first direction to overlap the first conductor and the second conductor,
the fourth coupling conductor is disposed at a position away in the first direction to overlap the second conductor and the third conductor,
the fifth coupling conductor is disposed at a position away in the first direction to overlap the third conductor and the fourth conductor, and
the sixth coupling conductor is disposed at a position away in the first direction to overlap the fourth conductor and the first conductor.

4. The antenna element according to claim 2, wherein
the first power feeding conductor and the second power feeding conductor are configured to be located on a diagonal line of the square lattice.

5. The antenna element according to claim 2, wherein
the second coupling conductor comprises a seventh coupling conductor, an eighth coupling conductor, a ninth coupling conductor, a tenth coupling conductor, a first connector configured to electromagnetically couple the seventh coupling conductor and the ninth coupling conductor to each other, and a second connector configured to electromagnetically couple the eighth coupling conductor and the tenth coupling conductor to each other,
the seventh coupling conductor is disposed at a position away in the first direction and at least a part of the seventh coupling conductor overlaps the first conductor,
the eighth coupling conductor is disposed at a position away in the first direction and at least a part of the eighth coupling conductor overlaps the second conductor,
the ninth coupling conductor is disposed at a position away in the first direction and at least a part of the ninth coupling conductor overlaps the third conductor,
the tenth coupling conductor is disposed at a position away in the first direction and at least a part of the tenth coupling conductor overlaps the fourth conductor, and
the first connector and the second connector are configured to be electromagnetically connected to each other.

6. An antenna element comprising:
a first conductor provided with a first resonator, a second resonator, a third resonator, and a fourth resonator in a loop shape, wherein
the first conductor capacitively couples the first resonator, the second resonator, the third resonator, and the fourth resonator in common,
resonators facing each other, among the first resonator, the second resonator, the third resonator, and the fourth resonator, are respectively provided with a first port and a second port inputting alternating currents of the same frequency, and
the antenna element is configured to control a mode by a phase difference of the alternating currents of the same frequency from the first port and the second port.

7. An array antenna comprising:
a plurality of the antenna elements according to claim 1.
